(19) United States
(12) Patent Application Publication
(10) Pub. No.: US 2006/0285093 A1
(43) Pub. Date: Dec. 21, 2006

(54) Immersion exposure apparatus

(75) Inventors: Shinichi Hara, Yokohama-shi (JP); Noriyasu Hasegawa, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/451,303

(22) Filed: Jun. 13, 2006

(30) Foreign Application Priority Data
Jun. 21, 2005 (JP) 2005-180543

(51) Int. Cl. G03B 27/52

(52) U.S. Cl. 355/30; 355/53

(57) ABSTRACT

An exposure apparatus includes a projection optical system configured to project an image of a pattern of a reticle onto a substrate. The exposure apparatus exposes the substrate via the projection optical system and a liquid that is disposed between the projection optical system and the substrate. The exposure apparatus includes a top plate configured to hold the substrate, an auxiliary plate disposed around the substrate on the top plate and having a surface that is substantially flush with a surface of the substrate, and a mirror disposed on the top plate for use in measuring at least one of a position of the top plate and an orientation of the top plate. The auxiliary plate preferably is formed of a low-thermal-expansion material having a coefficient of linear expansion of no greater than 100 ppb.

### BACKGROUND OF THE INVENTION

1. Field of the Invention

The present invention relates to an exposure apparatus used in a lithography process for manufacturing a device (e.g., a semiconductor device or liquid crystal display device). In particular, the present invention relates to an exposure apparatus that includes a projection optical system for projecting an image of a pattern of a reticle (photomask) onto a photosensitive substrate and that exposes the photosensitive substrate via the projection optical system and a liquid disposed between the projection optical system and photosensitive substrate, a so-called immersion exposure apparatus.

2. Description of the Related Art

A projection exposure apparatus is used to project an image of a circuit pattern formed on a reticle as a master onto a wafer or glass plate, acting as a photosensitive substrate, thereby exposing the photosensitive substrate.

In such a projection exposure apparatus, a reticle stage and a wafer stage are scanned simultaneously in accordance with a velocity ratio proportional to the demagnification ratio. Here, it is assumed that the direction of scanning is X, the direction perpendicular to the X direction is Y, and the direction perpendicular to a surface of the reticle or wafer is Z.

The reticle is held by a reticle chuck on the reticle stage. The reticle stage has a mechanism that moves in the X direction at high velocity. The reticle stage has a fine adjustment mechanism that precisely moves in the X, Y, and Z directions and the rotational directions about the X, Y, and Z directions so that the reticle can be positioned. The position and orientation of the reticle stage is measured by a laser interferometer and is controlled on the basis of the measurement.

The wafer is held by a stage top plate via a wafer chuck. The stage top plate has a mechanism that moves in the X and Y directions at high velocity. The stage top plate has a fine adjustment mechanism that finely moves in each of the X, Y, and Z directions and the rotational directions about the X, Y, and Z directions so that the wafer can be positioned. The position of the stage top plate is determined by measuring the position of a reference mirror on the stage top plate using a laser interferometer. On the basis of the measurement, the position and orientation of the wafer are controlled.

Today, the provision of high-resolution and economical exposure apparatuses is increasingly desired. As a means to satisfy the demand for high resolution, immersion exposure is attracting much attention. Immersion exposure is a technique that further promotes an increase in the numerical aperture (NA) of a projection optical system by filling the gap between the projection optical system and the wafer with a liquid.

Since NA=n sin θ, wherein n is the refractive index of the image medium, NA can be increased by up to n times by filling the gap with an image medium having a refractive index higher than that of air, i.e., n>1.

As a result, the resolution R of an exposure apparatus, given by R=k1(λ/NA), wherein k1 is a process factor and λ is the wavelength of a light source, can be reduced.

Regarding immersion exposure, an exposure apparatus that locally fills the gap between a final face of a projection optical system and an opposing surface of a wafer with a liquid, a so-called local-fill technology, is discussed in, for example, International Publication No. WO 99/49504.

Such a local-fill-type exposure apparatus requires a special mechanism to hold a liquid locally in the gap between the final face of the projection optical system and the opposing surface of the wafer while allowing exposure of the outer region of the wafer. To this end, an exposure apparatus that includes a flush plate which is adjacent to the outer region of the wafer and which is substantially flush with the surface of the wafer in the direction of gravity on the top plate of the stage is discussed in, for example, Japanese Patent Laid-Open Nos. 2004-289127, 2002-158154, 2005-101488, and 2005-72132.

However, as shown in FIG. 11, a thin layer of a liquid film LM that has been held locally in the gap between the final face of a projection optical system 30 and an opposing surface of a wafer 40 during the scanning of the wafer remains on the wafer after the exposure. When that thin layer of remaining liquid evaporates, the temperature of the wafer decreases, causing the wafer to be thermally deformed (i.e., contracted). This reduces the positional accuracy of the pattern transferred to the wafer. Additionally, when the outer region of the wafer is exposed, a thin layer of the liquid film LM also remains on a flush plate 44, which is substantially flush with the surface of the wafer. When that thin layer of remaining liquid is vaporized, the temperature of the flush plate decreases, causing the flush plate to be thermally deformed (i.e., contracted), which in turn causes a top plate 41 supporting the flush plate 44 to be deformed. The deformation of the top plate varies the position of a reference mirror 54 of a laser interferometer on the top plate, and, as a result, the accuracy with which the position and orientation of the wafer can be controlled decreases.

### SUMMARY OF THE INVENTION

An exposure apparatus according to one aspect of the present invention includes a projection optical system configured to project an image of a pattern of a reticle onto a substrate. The exposure apparatus exposes the substrate via the projection optical system and a liquid that is disposed between the projection optical system and the substrate. The exposure apparatus includes a top plate configured to hold the substrate, an auxiliary plate disposed around the substrate on the top plate and having a surface that is substantially flush with a surface of the substrate, and a mirror disposed on the top plate for use in measuring at least one of a position of the top plate and an orientation of the top plate. The auxiliary plate preferably is formed of a low-thermal-expansion material having a coefficient of linear expansion of no greater than 100 ppb.

A method of manufacturing a device according to another aspect of the present invention includes an exposure step of exposing a substrate by using the exposure apparatus described above, and a development step of developing the exposed substrate.

Further features of the present invention will become apparent from the following description of exemplary embodiments, with reference to the accompanying drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 illustrates an exposure apparatus according to a first exemplary embodiment of the present invention.

FIG. 2 illustrates the vicinity of a wafer in the exposure apparatus according to one aspect of the first exemplary embodiment.

FIG. 3 illustrates the vicinity of the wafer in the exposure apparatus according to another aspect of the first exemplary embodiment.

FIG. 4 illustrates the vicinity of the wafer in the exposure apparatus according to yet another aspect of the first exemplary embodiment.

FIG. 5 illustrates the vicinity of the wafer in the exposure apparatus according to a second exemplary embodiment.

FIG. 6 illustrates the vicinity of the wafer in the exposure apparatus according to one aspect of a third exemplary embodiment.

FIG. 7 illustrates the vicinity of the wafer in the exposure apparatus according to another aspect of the third exemplary embodiment.

FIG. 8 illustrates the vicinity of the wafer in the exposure apparatus according to a fourth exemplary embodiment.

FIG. 9 is a flowchart for explaining a method of manufacturing a device.

FIG. 10 is a flowchart that shows the details of a wafer process in step S4 of the method illustrated in FIG. 9.

FIG. 11 illustrates the vicinity of a wafer in a conventional exposure apparatus.

### DESCRIPTION OF THE EMBODIMENTS

Exemplary embodiments of the present invention are described below with reference to the accompanying drawings. In the drawings, the same reference numerals are used for the same elements, and redundant explanations of elements are omitted.

### First Exemplary Embodiment

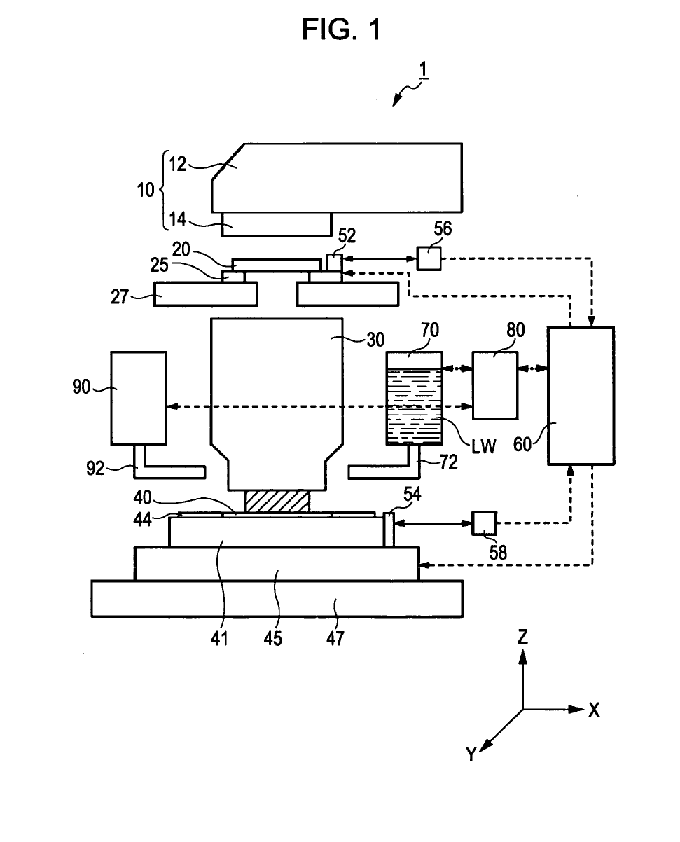

With reference to FIG. 1, an exposure apparatus 1 according to the first exemplary embodiment is described below.

The exposure apparatus 1 is an immersion projection exposure apparatus that exposes a wafer 40 to transfer a circuit pattern formed on a reticle 20 to the wafer 40 by a step-and-scan system via a liquid (immersion liquid) LW supplied between a final face (final optical element) of a projection optical system 30 and the wafer 40. The step-and-scan system utilizes an exposure technique in which a pattern formed on reticle is transferred to the wafer by continuously scanning an area of the wafer with respect to the reticle and stepping the wafer to expose the next exposure area of the wafer after one-shot exposure ends. Alternatively, the present invention is also applicable to an immersion projection exposure apparatus that uses a step-and-repeat system. The step-and-repeat system utilizes an exposure technique in which an area of the wafer is exposed by block exposure and then the wafer is stepped to expose the next exposure area after the block exposure ends.

As shown in FIG. 1, the exposure apparatus 1 includes an illumination device 10, a reticle stage 25 on which the reticle 20 can be placed, the projection optical system 30, a wafer stage 45 on which the wafer 40 can be placed, distance-measuring devices (including mirrors 52 and 54 and laser interferometers 56 and 58), a stage controller 60, a liquid supply unit 70, an immersion controller 80, and a liquid recovery unit 90.

The illumination device 10 illuminates the reticle 20 on which a circuit pattern is formed and includes a light source unit 12 and an illumination optical system 14.

In the first exemplary embodiment, the light source unit 12 includes an ArF excimer laser with a wavelength of 193 nm as the light source. However, the light source in the light source unit 12 is not limited to the ArF excimer laser. For example, a KrF excimer laser with a wavelength of approximately 248 nm or an F2 laser with a wavelength of approximately 157 nm can be used.

The illumination optical system 14 is an optical system that illuminates the reticle 20 and includes a lens, a mirror, an optical integrator, and a stop. For example, the illumination optical system 14 may include a condenser, a fly-eye lens, an aperture stop, a condenser, a slit, and an image-forming optical system, arranged in that order. An example of a suitable optical integrator is an integrator in which a fly-eye lens and two sets of cylindrical lens array (or lenticular lens) plates are superposed. Alternatively, the optical integrator can be replaced with an optical rod or a diffraction grating.

The reticle 20 is conveyed from outside the exposure apparatus 1 by a reticle conveying system (not shown) and is supported and driven by the reticle stage 25. The reticle 20 is made of, for example, quartz, and a circuit pattern to be transferred is formed thereon. Diffraction rays from the reticle 20 pass through the projection optical system 30 and a liquid film LM and are projected onto the wafer 40. The locations of the reticle 20 and the wafer 40 are conjugate to each other. The exposure apparatus 1 transfers the pattern formed on the reticle 20 to the wafer 40 by scanning the reticle 20 and the wafer 40 at a velocity ratio corresponding to the demagnification ratio.

The reticle stage 25 is mounted on a surface plate 27 for fixing the reticle stage 25. The reticle stage 25 supports the reticle 20 via a reticle chuck (not shown), and the movement of the reticle stage 25 is controlled by a translation mechanism (not shown) and the stage controller 60. The translation mechanism is constructed of a linear motor or the like and is capable of moving the reticle 20 by driving the reticle stage 25 in the X-axis direction.

The projection optical system 30 functions to form an image on the wafer 40 with diffraction rays that have passed through the pattern formed on the reticle 20. The projection optical system 30 can comprise a refraction optical system consisting only of a plurality of lens elements, a catadioptric optical system including a plurality of lens elements and at least one concave mirror, or other known systems.

The wafer 40 is conveyed from outside the exposure apparatus 1 by a wafer conveying system (not shown) and is supported and driven by the wafer stage 45. The wafer 40 in the first exemplary embodiment can be a liquid crystal substrate or any other photosensitive substrate. The wafer 40 is coated with a photoresist.

A flush plate 44 is an auxiliary plate that surrounds and is substantially flush with a surface of the wafer 40. The flush plate 44 includes a surface that is substantially flush with the surface of the wafer 40. The flush plate 44 is often used in immersion exposure and allows the liquid film LM to be formed on an area outside the wafer 40, as well as on the wafer. Forming the liquid film LM on the area outside the wafer 40 enables the performance of a shot on the edge of the wafer by immersion exposure.

The wafer stage 45 is mounted on a base 47 and supports the wafer 40 via a wafer-stage top plate 41 and a wafer chuck (not shown).

The wafer stage 45 functions to adjust the position of the wafer 40 in the vertical and rotational directions and to adjust the inclination of the wafer. The wafer stage 45 is controlled by the stage controller 60. During exposure, the wafer stage 45 is controlled by the stage controller 60 so that the surface of the wafer 40 being exposed continuously coincides with a focal plane of the projection optical system 30 with high precision.

The distance-measuring devices measure the position of the reticle stage 25 and the two-dimensional position of the wafer stage 45 in real time via the reference mirrors 52 and 54 and the laser interferometers 56 and 58.

Those measurements are transmitted to the stage controller 60. The reticle stage 25 and the wafer stage 45 are driven at a constant velocity ratio under control of the stage controller 60 so that the reticle stage 25 and the wafer stage 45 can be positioned and the synchronization thereof can be controlled.

The stage controller 60 controls driving of the reticle stage 25 and the wafer stage 45.

The liquid supply unit 70 functions to supply the liquid LW to the gap between the projection optical system 30 and the wafer 40 and, in the first exemplary embodiment, includes a generator, a deaerator, a temperature controller (all of which are not specifically shown), and a liquid supply pipe arrangement 72. The liquid supply unit 70 supplies the liquid LW via the liquid supply pipe arrangement 72 disposed in the vicinity of the final face of the projection optical system 30, thereby forming the liquid film LM in the gap between the projection optical system 30 and the wafer 40. The distance between the projection optical system 30 and the wafer 40 should be sufficient to allow the liquid film LM to be stably formed and to be removed. A distance of 1.0 mm is preferred.

The liquid supply unit 70 can include, for example, a tank for storing the liquid LW, a pumping unit for discharging the liquid LW, and a flow control unit for controlling the flow rate of the liquid LW being supplied.

The liquid LW preferably is selected so that the amount of absorbed exposure light is small. The liquid LW can have a refractive index that is substantially the same as that of a refractive optical element, such as one formed of quartz or fluorite. More specifically, examples of the liquid LW include pure water, functional water, and fluorinated liquid (e.g., fluorocarbon). The liquid LW can be a liquid whose dissolved gas has been sufficiently removed in advance by using a deaerator (not shown). In this case, the appearance of bubbles can be suppressed, and, even if a bubble forms, the bubble can be immediately absorbed in the liquid LW. For example, with respect to nitrogen and oxygen, which are largely contained in air, if 80% or more of the amount of gas dissolvable in the liquid LW is removed, the appearance of bubbles can be sufficiently suppressed. When the exposure apparatus includes the deaerator (not shown), the liquid LW can be supplied to the liquid supply unit 70 while dissolved gas is being removed continuously by the deaerator.

The generator reduces impurities (e.g., metal ions, particles, and organic substances) contained in raw water supplied from a raw-water supply source (not shown) and generates the liquid LW. The liquid LW generated by the generator is supplied to the deaerator.

The deaerator performs deaeration on the liquid LW, thereby reducing dissolved oxygen and nitrogen in the liquid LW. The deaerator can include, for example, a film module and a vacuum pump. The deaerator can be a unit that passes the liquid LW to a first area through a gas permeable film, produces a vacuum in a second area on a side of the gas permeable film opposite from the first area, and expels the dissolved gas in the liquid LW to the vacuum via the film.

The temperature controller functions to control the temperature of the liquid LW so as to maintain the liquid LW at a predetermined temperature.

The liquid supply pipe arrangement 72 can be formed of a resin that has a small amount of elution, such as a Teflon® resin, polyethylene resin, or polypropylene resin, in order to prevent the liquid LW from being contaminated. In the case where the liquid LW is a liquid other than pure water, the liquid supply pipe arrangement 72 is formed from a material that is resistant to the liquid LW and that has a small amount of elution.

The immersion controller 80 retrieves from the stage controller 60 information regarding the current position, speed, acceleration, target position, and direction of movement of the wafer stage 45, and, on the basis of that information, controls the immersion exposure process. The immersion controller 80, for example, provides the liquid supply unit 70 and the liquid recovery unit 90 with control instructions on switching between supply and recovery of the liquid LW, stopping the supply or recovery of the liquid LW, and regulating the amount of the liquid LW to be supplied or recovered.

The liquid recovery unit 90 functions to recover the liquid LW supplied from the liquid supply unit 70, and, in this first exemplary embodiment, includes a liquid recovery piping arrangement 92. The liquid recovery unit 90 also can include, for example, a tank for temporarily storing the recovered liquid LW, a suction unit for drawing up the liquid LW, and a flow control unit for controlling the flow rate of the liquid LW being recovered.

The liquid recovery piping arrangement 92 can be formed of a resin that has a small amount of elution, such as a Teflon® resin, polyethylene resin, or polypropylene resin, in order to prevent the liquid LW from being contaminated. In the case where the liquid LW is a liquid other than pure water, the liquid recovery piping arrangement 92 is formed from a material that is resistant to the liquid LW and that has a small amount of elution.

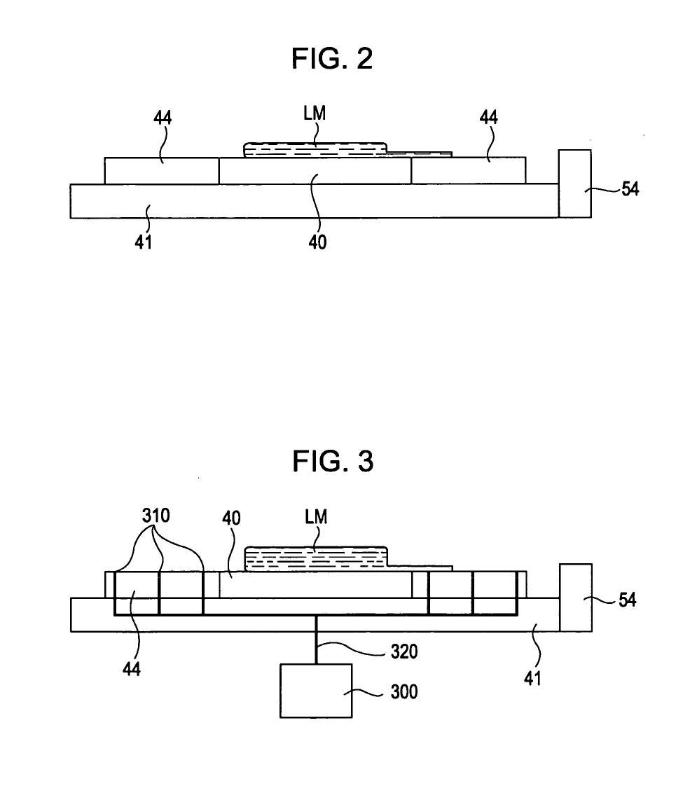

The elements disposed in the vicinity of the wafer in the exposure apparatus according to the first exemplary embodiment are described below with reference to FIG. 2.

As shown in FIG. 2, the flush plate 44 is formed of a low-thermal-expansion material, and therefore, even when a thin layer of the liquid film LM remaining on the surface of the flush plate 44 vaporizes and the temperature of the flush plate 44 is reduced due to the heat of vaporization, the amount of thermal deformation of the flush plate 44 can be suppressed to be no greater than 1 nm because the flush plate 44 has a small coefficient of linear expansion of no greater than 100 ppb. As a result, a change in the position of the reference mirror 54 caused by a deformation of the wafer-stage top plate 41 that occurs when the flush plate 44 is thermally deformed (i.e., contracted) can be reduced. This allows the position and orientation of the wafer to be controlled stably. The low-thermal-expansion material can be silicon dioxide (SiO₂) with a coefficient of linear expansion of no greater than 100 ppb, or a ceramic (glass ceramic) that contains SiO₂ (e.g., ZERODUR™ and ULE™). In this case, even when a ceramic that contains SiO₂ is radiated with high-energy light having a short wavelength, such as an ArF laser, the surface of the ceramic is resistant to changes, and therefore, the possibility of a defect caused by particles forming on the surface can be reduced. However, since a ceramic that contains SiO₂ (e.g., ZERODUR™ and ULE™) has a hydrophilic surface with a contact angle of no greater than 30°, it might be difficult for the liquid recovery unit alone to readily recover the liquid LW on the wafer and the flush plate. As a result, the liquid LW may spatter from the liquid film LM while the stage is driven, and this might cause, for example, a malfunction of an electronic component or rust.

To address this problem, as shown in FIG. 3, the flush plate 44 can be provided with a liquid recovery system. More specifically, a structure can be used that recovers the liquid LW remaining on the flush plate 44 by including a hole (or groove) 310 in the surface of the flush plate 44 and connecting the hole (or groove) 310 to a vacuum source 300 via a piping arrangement 320. This structure allows the liquid LW to be recovered easily, even when the surface of the flush plate 44, which is mainly formed of a low-thermal-expansion material, is hydrophilic and has a small contact angle. FIG. 3 illustrates the vicinity of the wafer in the exposure apparatus according to this aspect of the first exemplary embodiment.

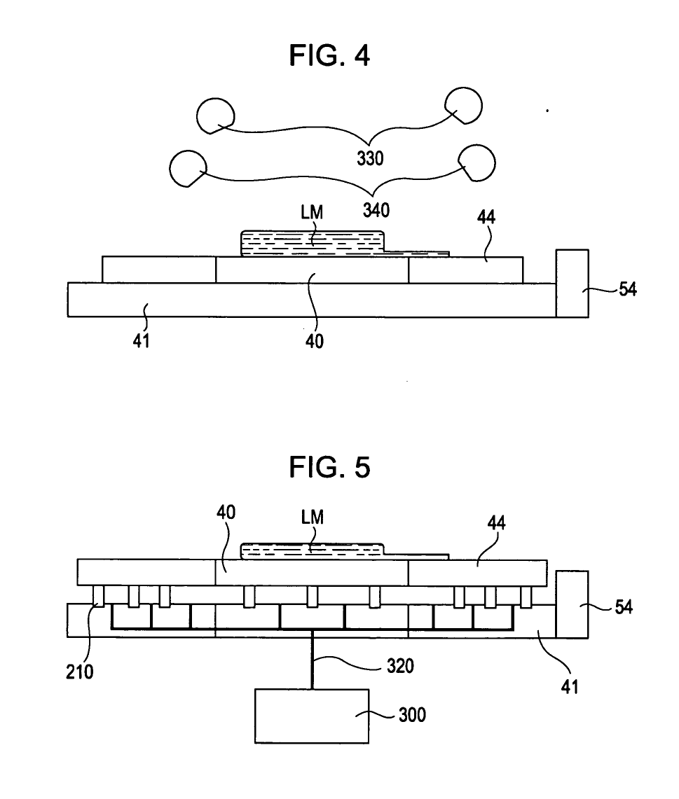

As shown in FIG. 4, in the exposure apparatus according to the first exemplary embodiment, a structure can be used that senses the temperature of the wafer 40 with a temperature sensor 330 disposed adjacent to the surface of the wafer 40 in a noncontact manner and, on the basis of the result of sensing, heats the wafer 40 with a heating unit 340 in a noncontact manner. The temperature sensor 330 can be a thermopile, and the heating unit 340 can be a lamp. The temperature of the wafer 40 thus can be adjusted so as to be the same as the temperature of an exposure atmosphere in the exposure apparatus. This can suppress the vaporization of any thin layer of the liquid film LM that remains on the surface of the wafer and thus can suppress a decrease in the temperature of the wafer due to the heat of vaporization. In the first exemplary embodiment discussed above, the flush plate 44 is formed of a low-thermal-expansion material. Alternatively, when the heating unit 340 is capable of locally heating a predetermined area, the heating unit 340 can locally heat a vaporizing area of the liquid film LM on the wafer 40 and the flush plate 44, instead of forming the flush plate 44 from a low-thermal-expansion material. FIG. 4 illustrates the vicinity of the wafer in the exposure apparatus according to this aspect of the first exemplary embodiment.

### Second Exemplary Embodiment

The exposure apparatus according to another exemplary embodiment of the present invention is described below with reference to FIG. 5. FIG. 5 illustrates the vicinity of the wafer in the exposure apparatus according to the second exemplary embodiment.

In the second exemplary embodiment, the wafer-stage top plate 41 supports the flush plate 44 atop a plurality of protrusions 210.

Other elements are the same as those in the first exemplary embodiment, and the explanation thereof is not repeated here.

With the exposure apparatus according to the second exemplary embodiment, according to the structure described above, the thermal resistance of the flush plate 44 and the wafer-stage top plate 41 is increased and thus the amount of heat transferred from the flush plate 44 to the wafer-stage top plate 41 is suppressed. Therefore, even when a thin layer of the liquid film LM that remains on the surface of the flush plate 44 vaporizes, thus reducing the temperature of the flush plate 44 due to the heat of vaporization, thermal deformation of the wafer-stage top plate 41 is suppressed because the amount of heat transferred to the wafer-stage top plate 41 is suppressed. Therefore, a decrease in the accuracy with which the position and orientation of the wafer can be controlled, caused by a change in the position of the reference mirror 54 of the laser interferometer disposed on the wafer-stage top plate 41, can be suppressed.

Additionally, in the second exemplary embodiment, in order to hold the flush plate 44 more securely, the flush plate 44 is attracted and held to the wafer-stage top plate 41 by applying a vacuum force to the underside of the flush plate 44 via the vacuum source 300 and the piping arrangement 320. This structure enables the flush plate 44 to be fixed under acceleration and deceleration when the stage is moved at high speeds. In addition, this structure is advantageous in that it suppresses the amount of heat transferred from the flush plate 44 to the wafer-stage top plate 41 because the contact thermal resistance of the protrusions 210 and the flush plate 44 is increased.

### Third Exemplary Embodiment

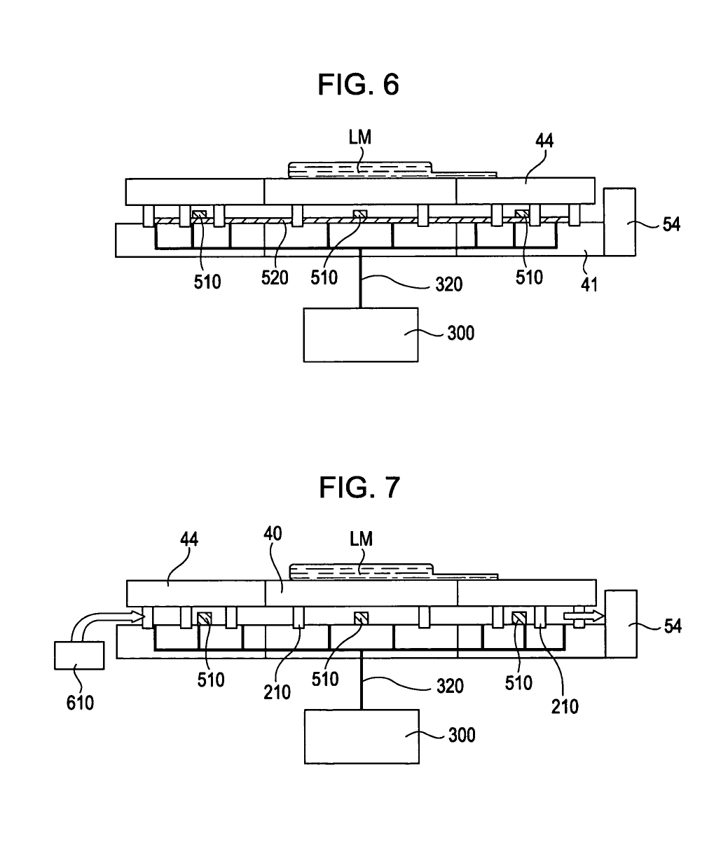

The exposure apparatus according to still another exemplary embodiment of the present invention is described below with reference to FIG. 6. FIG. 6 illustrates the vicinity of the wafer in the exposure apparatus according to the third exemplary embodiment.

In the third exemplary embodiment, a temperature sensor 510 and a heater 520, which acts as the heating unit, are arranged on the surface of the wafer-stage top plate 41. Other elements are the same as those in the second exemplary embodiment, and the explanation thereof is not repeated here.

The temperature sensor 510 on the surface of the wafer-stage top plate 41 monitors the temperature of the wafer-stage top plate 41, so that the heater 520 can be adjusted to continuously maintain the wafer-stage top plate 41 at a predetermined temperature. In other words, even when a thin layer of the liquid film LM that remains on the surface of the wafer 40 vaporizes, causing the temperature of the wafer 40 to be reduced due to the heat of vaporization, in turn causing the temperature of the wafer-stage top plate 41 to decrease accordingly, the wafer-stage top plate 41 can be heated by the heater 520 in order to maintain a predetermined temperature. This structure thus reduces deformation of the wafer-stage top plate 41 and also reduces a change in the position of the reference mirror 54. Additionally, even when the liquid LW remaining on the flush plate 44 vaporizes and the temperature of the flush plate 44 is thus reduced, causing the temperature of the wafer-stage top plate 41 to decrease, the wafer-stage top plate 41 can be heated by the heater 520. As a result, deformation of the wafer-stage top plate 41 can be reduced, and a change in the position of the reference mirror 54 can be reduced.

With this structure, although the heater 520 is not in contact with the wafer 40 or the flush plate 44, a decrease in the temperature of each of the wafer 40 and the flush plate 44 is prevented by radiant heat from the heater 520. Therefore, a deformation of the wafer-stage top plate 41 caused by a decrease in the temperature of each of the wafer 40 and the flush plate 44 is also reduced. For the flush plate 44, the decrease in the temperature thereof may be prevented by arranging the temperature sensor 510 and the heater 520 directly on the underside of the flush plate 44. In this case, the deformation of the wafer-stage top plate 41 caused by the decrease in the temperature of the flush plate 44 can be further reduced. In the case where a decrease in the temperature due to the heat of vaporization is present locally, in order to address the decrease in the temperature more effectively, a plurality of temperature sensors and a plurality of heaters can be used.

As shown in FIG. 7, a gas supply unit (heating unit) 610 can be used to send a high-temperature gas across the underside of the flush plate 44 and the underside of the wafer 40. The temperature of the gas can be adjusted such that a measurement value of the temperature sensor 510 is continuously maintained at a predetermined temperature. This structure can suppress a decrease in the temperature of the wafer 40 due to the heat of vaporization that occurs when a thin layer of the liquid film LM that remains on the surface of the wafer 40 vaporizes. Similarly, this structure can suppress a decrease in the temperature of the flush plate 44 due to the heat of vaporization. Additionally, this structure is advantageous in that space is not limited by the location of the heater 520. FIG. 7 illustrates the vicinity of the wafer in the exposure apparatus according to this aspect of the third exemplary embodiment.

### Fourth Exemplary Embodiment

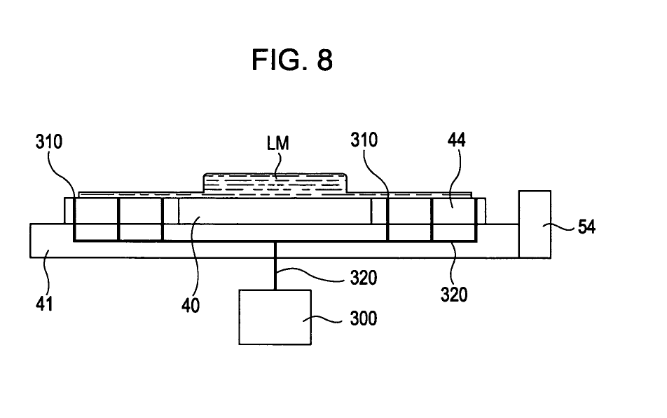

The exposure apparatus according to yet another exemplary embodiment of the present invention is described below with reference to FIG. 8. FIG. 8 illustrates the vicinity of the wafer in the exposure apparatus according to the fourth exemplary embodiment.

In the fourth exemplary embodiment, the amount of the liquid LW recovered by the liquid supply unit 70 per unit time is set so as to be smaller than that supplied from the liquid recovery unit 90. In the fourth exemplary embodiment, as in the first exemplary embodiment (FIG. 3), the flush plate 44 is provided with the liquid recovery system, and the flush plate 44 is formed of SiO₂ with a surface having a contact angle of no greater than 30° or a ceramic (glass ceramic) that contains SiO₂ (e.g., ZERODUR™ and ULE™).

Other elements are the same as those in the first exemplary embodiment, and the explanation thereof is not repeated here.

In the exposure apparatus according to the fourth exemplary embodiment, since the amount of the liquid LW recovered by the liquid supply unit 70 per unit time is set so as to be smaller than that supplied from the liquid recovery unit 90, a relatively thick layer of the liquid film LM remains on the surface of the wafer or the surface of the flush plate during exposure of the outer region of the wafer. As a result, even when the upper surface of the liquid film LM vaporizes, the temperature of the bottom of the liquid film LM does not decrease immediately, and therefore, a decrease in the temperature of the surfaces of the wafer 40 and the flush plate 44 takes much longer. As a result, deformation of the wafer 40 and the flush plate 44 occurring over a predetermined period of time can be suppressed to an allowable level.

### Fifth Exemplary Embodiment

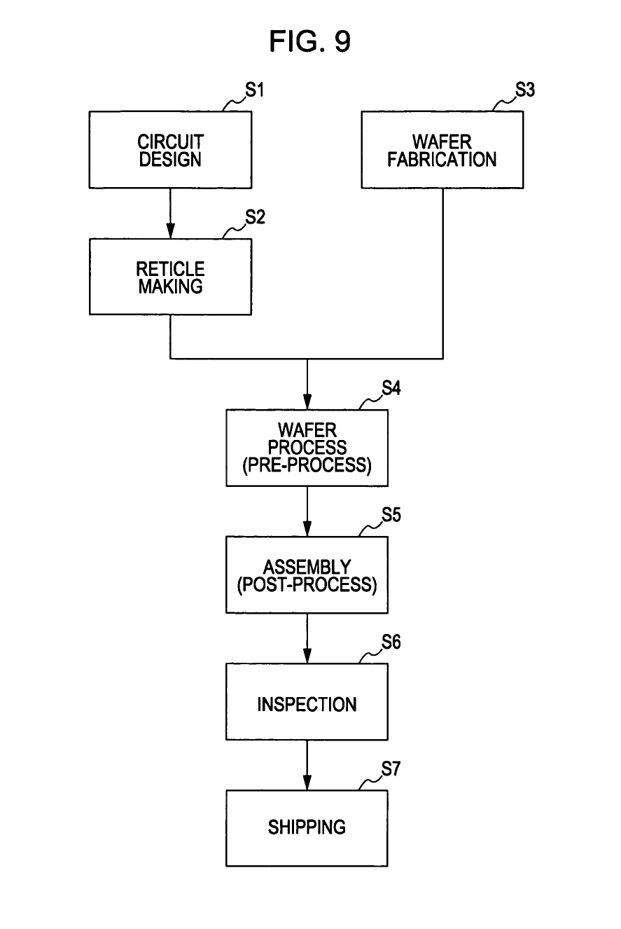

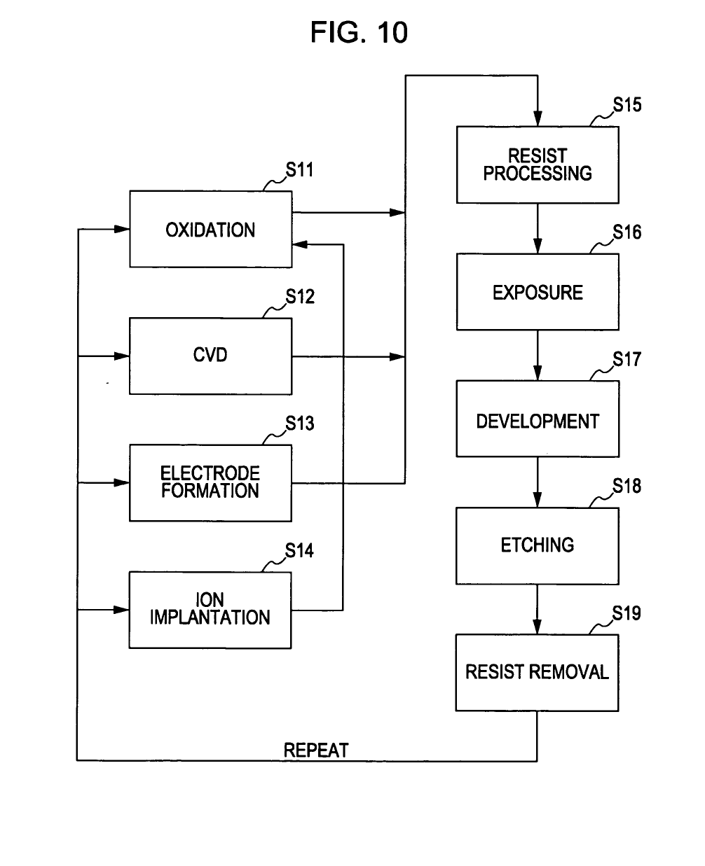

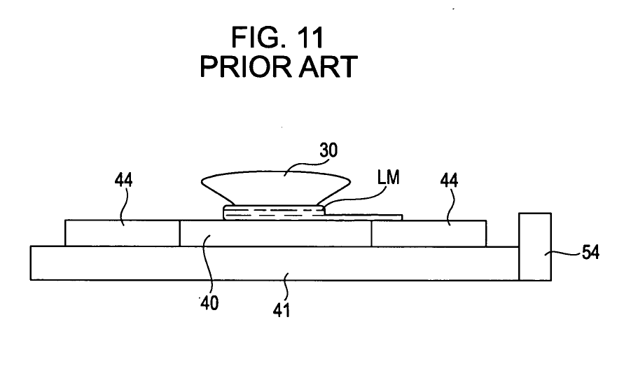

A method of manufacturing a device using the exposure apparatus, as described in the above embodiments, is described below with reference to FIGS. 9 and 10. FIG. 9 is a flowchart for explaining the method of manufacturing a device (e.g., a semiconductor device or liquid crystal display device). Here, the manufacture of a semiconductor chip is described as an example. In step S1 (circuit design), a device circuit is designed. In step S2 (reticle making), a reticle on which a designed circuit pattern is formed is prepared. In step S3 (wafer fabrication), a wafer is fabricated using a material such as silicon. In step S4 (wafer process), which is called a pre-process, an actual circuit is formed on the wafer by lithography according to the present invention using the prepared reticle and wafer. Step S5 (assembly), which is called a post-process, is a step that produces the form of a semiconductor chip by using the wafer formed in step S4, and includes an assembly process (dicing and bonding) and packaging process (chip encapsulation). In step S6 (inspection), inspections, such as an operation confirmation test and a durability test of the semiconductor device formed in step S5, are conducted. The manufacture of the semiconductor device is completed after these steps, and then the semiconductor device is shipped (step S7).

FIG. 10 is a flowchart that shows the details of the wafer process illustrated in step S4 of FIG. 9. In step S11 (oxidation), the wafer surface is oxidized. In step S12 (chemical-vapor deposition (CVD)), an insulating film is formed on the wafer surface. In step S13 (electrode formation), an electrode is formed on the wafer by vapor deposition or another known method. In step S14 (ion implantation), ions are implanted in the wafer. In step S15 (resist processing), the wafer is coated with a photosensitive agent. In step S16 (exposure), the exposure apparatus described above exposes the wafer to transfer the circuit pattern formed on the reticle to the wafer. In step S17 (development), the exposed wafer is developed. In step S18 (etching), an area where the developed resist image is absent is removed. In step S19 (resist removal), the resist which is unnecessary after etching has been completed is removed. These steps are repeated to form multiple circuit patterns on the wafer. The method of manufacturing a device described above achieves the manufacture of a high-quality device. The method of manufacturing a device using the exposure apparatus and the device as a result of the manufacture constitute one aspect of the present invention.

Except as otherwise discussed herein, the various components shown in outline or block form in the Figures are individually well known and their internal construction and operation are not critical either to the making or using of the invention or to a description of the best mode of the invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Application No. 2005-180543 filed Jun. 21, 2005, which is hereby incorporated by reference herein in its entirety.

What is claimed is:

1. An exposure apparatus for exposing a substrate via a projection optical system and a liquid that is disposed between the projection optical system and the substrate, the exposure apparatus comprising:
a projection optical system configured to project an image of a pattern of a reticle onto a substrate;
a top plate configured to hold the substrate;
an auxiliary plate disposed around the substrate on the top plate and having a surface that is substantially flush with a surface of the substrate, the auxiliary plate being formed of a low-thermal-expansion material having a coefficient of linear expansion of no greater than 100 ppb.; and
a mirror disposed on the top plate for use in measuring at least one of a position of the top plate and an orientation of the top plate.

2. The exposure apparatus of claim 1, wherein the low-thermal-expansion material is SiO₂ or a ceramic containing SiO₂.

3. An exposure apparatus for exposing a substrate via a projection optical system and a liquid that is disposed between the projection optical system and the substrate, the exposure apparatus comprising:
a projection optical system configured to project an image of a pattern of a reticle onto a substrate;
a top plate configured to hold the substrate;
an auxiliary plate disposed around the substrate on the top plate and having a surface that is substantially flush with a surface of the substrate, the surface of the auxiliary plate being formed of a hydrophilic material having a contact angle of no greater than 30°; and
a mirror disposed on the top plate for use in measuring at least one of a position of the top plate and an orientation of the top plate.

4. The exposure apparatus of claim 3, wherein the hydrophilic material is SiO₂ or a ceramic containing SiO₂.

5. The exposure apparatus of claim 1, wherein the auxiliary plate includes at least one hole through which the liquid can be recovered.

6. The exposure apparatus of claim 5, further comprising:
a supply unit configured to supply the liquid onto the substrate; and
a recovery unit configured to recover the liquid from the substrate,
wherein the volume of the liquid supplied from the supply unit is larger than the volume of the liquid recovered by the recovery unit.

7. An exposure apparatus for exposing a substrate via a projection optical system and a liquid that is disposed between the projection optical system and the substrate, the exposure apparatus comprising:
a projection optical system configured to project an image of a pattern of a reticle onto a substrate;
a top plate configured to hold the substrate;
an auxiliary plate disposed around the substrate on the top plate and having a surface that is substantially flush with a surface of the substrate, the auxiliary plate being held by the top plate via a plurality of protrusions; and
a mirror disposed on the top plate for use in measuring at least one of a position of the top plate and an orientation of the top plate.

8. The exposure apparatus of claim 7, wherein the auxiliary plate is attracted to and held on the top plate by application of a vacuum force.

9. The exposure apparatus of claim 7, further comprising a heating unit disposed on the top plate.

10. The exposure apparatus of claim 9, further comprising a temperature sensor disposed on the top plate.

11. The exposure apparatus of claim 7, further comprising a heating unit disposed on a surface of the auxiliary plate that is adjacent to the top plate.

12. The exposure apparatus of claim 11, further comprising a temperature sensor disposed on the surface of the auxiliary plate that is adjacent to the top plate.

13. An exposure apparatus for exposing a substrate via a projection optical system and a liquid that is disposed between the projection optical system and the substrate, the exposure apparatus comprising:
a projection optical system configured to project an image of a pattern of a reticle onto a substrate;
a top plate configured to hold the substrate;
an auxiliary plate disposed around the substrate on the top plate and having a surface that is substantially flush with a surface of the substrate;
a mirror disposed on the top plate for use in measuring at least one of a position of the top plate and an orientation of the top plate; and
a heating unit configured to heat at least one of the substrate and the auxiliary plate in a noncontact manner.

14. The exposure apparatus of claim 13, further comprising a temperature sensor configured to sense a temperature of at least one of the substrate and the auxiliary plate in a noncontact manner.

15. An exposure apparatus for exposing a substrate via a projection optical system and a liquid that is disposed between the projection optical system and the substrate, the exposure apparatus comprising:
a projection optical system configured to project an image of a pattern of a reticle onto a substrate;
a top plate configured to hold the substrate;
an auxiliary plate disposed around the substrate on the top plate and having a surface that is substantially flush with a surface of the substrate;
a mirror disposed on the top plate for use in measuring at least one of a position of the top plate and an orientation of the top plate; and
a heating unit disposed between at least one of the auxiliary plate and the top plate, and the substrate and the top plate.

16. The exposure apparatus of claim 15, further comprising a temperature sensor disposed between at least one of the auxiliary plate and the top plate, and the substrate and the top plate.

17. A method of manufacturing a device, the method comprising the steps of:
exposing a substrate by using an exposure apparatus according to claim 1; and
developing the exposed substrate.

18. A method of manufacturing a device, the method comprising the steps of:
exposing a substrate by using an exposure apparatus according to claim 3; and
developing the exposed substrate.

19. A method of manufacturing a device, the method comprising the steps of:
exposing a substrate by using an exposure apparatus according to claim 7; and
developing the exposed substrate.

20. A method of manufacturing a device, the method comprising the steps of:
exposing a substrate by using an exposure apparatus according to claim 13; and
developing the exposed substrate.

21. A method of manufacturing a device, the method comprising the steps of:
exposing a substrate by using an exposure apparatus according to claim 15; and
developing the exposed substrate.
